(19) United States
(12) Patent Application Publication
(10) Pub. No.: US 2025/0099973 A1
(43) Pub. Date: Mar. 27, 2025

(54) MOBILE GLASS RECYCLING

(71) Applicant: Owens-Brockway Glass Container Inc., Perrysburg, OH (US)

(72) Inventors: Adam Hafer, Perrysburg, OH (US); Robert Hippert, Maumee, OH (US); Sammy Holaschutz, El Paso, TX (US)

(21) Appl. No.: 18/892,331

(22) Filed: Sep. 20, 2024

Related U.S. Application Data
(60) Provisional application No. 63/584,417, filed on Sep. 21, 2023.

(51) Int. Cl. B02C 23/14; B02C 19/00; B02C 21/02; B07B 13/16; B07B 13/18; B07B 15/00

(52) U.S. Cl. CPC B02C 23/14; B02C 21/02; B07B 13/16; B07B 13/18; B02C 19/0087; B07B 15/00

(57) ABSTRACT

A mobile glass recycling system and a related method are disclosed. The mobile glass recycling system may be transported from one location to another on a trailer and, once at a glass recycling destination, the glass recycling equipment stowed on the trailer in a transport configuration may be deployed to an operational configuration of the system. The glass recycling equipment carried on the trailer and deployed for recycling produces a stream of external cullet from a recyclable stream of glass that includes used glass artifacts. The glass recycling equipment includes at least a glass crushing apparatus to crush used glass artifacts into crushed glass pieces, a ferrous metal separating apparatus to separate out ferrous metal, and a non-ferrous metal separating apparatus to separate out non-ferrous metal.

### TECHNICAL FIELD

This patent application discloses innovations related to material handling and, more particularly, to glass recycling.

### BACKGROUND

Recycled glass or “cullet” is used at glass manufacturing plants in various forms. For example, a glass container manufacturing operation typically includes a glass melting furnace to melt a combination of raw materials and recycled glass to produce molten glass, and one or more container forming machines to shape and form glass containers from the molten glass. During container forming, a stream of the molten glass may be separated into a glass gob. The glass gob is formed into a glass parison, which, in turn, is shaped into a glass container. However, for a variety of reasons, glass gobs, parisons, containers, or pieces thereof may be rejected within the glass manufacturing plant and scrapped. These rejected materials, as well as streams of molten waste glass that are cooled and solidified, are referred to as “internal cullet.” Internal cullet may be returned to the glass furnace and remelted therein to produce more molten glass without much effort since the internal cullet has the correct glass chemistry and is generally uncontaminated.

In contrast to internal cullet, glass articles that are produced and shipped from a glass manufacturing plant and entered into commerce and which are later collected after use in whole or part, referred to herein as “used glass artifacts,” cannot simply be added back into a glass furnace in the same manner as internal cullet. An example of such a used glass artifact is a manufactured glass container that is packaged, shipped, filled with a product, labeled, sold to a customer for consumption of the product, and then eventually reclaimed in whole or in part. Reclaimed used glass artifacts cannot be directly introduced to a glass furnace in bulk because the used glass is typically accompanied by any of a variety of contaminants including ferrous metals such as steel container caps, non-ferrous metals such as aluminum container caps, paper and plastics (e.g., labels or wrappers), and organics such as adhesives. The collected used glass artifacts can, however, be processed to remove the various contaminants that might otherwise negatively affect the molten glass in a glass furnace. This recycled glass is referred to as “external cullet,” which may be sorted by color and remelted in a glass furnace in the same way as internal cullet. The term “furnace” is used broadly herein as a representative term that encompasses any continuous or batch operating structure used to melt raw materials and/or cullet to produce molten glass including, for example, conventional Siemens-style furnaces and submerged combustion melters.

The rate at which used glass artifacts are recycled into external cullet in the United States is believed to be about 30%. Increasing this rate would be beneficial since, in general, an increase in the proportion of recycled glass content added to a glass furnace results in a corresponding decrease in both raw material consumption and in carbon emissions while also improving the efficiency of the melting process since cullet melts at a lower temperature than a corresponding quantity of raw materials. The relatively low recycling rate in the United States and elsewhere is attributable to a lack of infrastructure capable of economically sorting, processing, and transporting used glass. More specifically, glass manufacturing plants typically receive used glass at prohibitive costs because current glass collection and transportation methods are inefficient, and glass crushing and cleaning is carried out with equipment that tends to be relatively complex, costly, and cumbersome. Currently, there is not a commercially successful mobile glass recycling system that can travel to a source of used glass artifacts—whether located at a recycling facility or at the glass manufacturing plant itself—and, once at the source, recycle the used glass artifacts into melt-ready external cullet.

### SUMMARY OF THE DISCLOSURE

A mobile glass recycle system is disclosed along with a method for recycling glass using the mobile glass recycling system. The mobile glass recycling system includes glass recycling equipment such as, for example, a glass crushing apparatus, a ferrous metal separating apparatus, a non-ferrous metal separating apparatus, and possibly other apparatuses as well such as an optional fines separating apparatus, one or more distribution apparatuses, and a dust control apparatus, to name but a few. The mobile glass recycling system can travel to a source of used glass artifacts and perform glass recycling at that location. To transport the mobile glass recycling system to its intended recycling destination, the system may be arranged into a transport configuration on a trailer and the trailer may be pulled, e.g., by a truck. When the mobile glass recycling system is at the recycling destination, the system may be deployed into an operational configuration and the glass recycling equipment is then operated to process a recyclable stream of glass, which includes used glass artifacts and is received by the glass recycling equipment, into a stream of external cullet delivered from the glass recycling equipment.

### BRIEF DESCRIPTION OF THE DRAWINGS

FIG. 1 is a perspective view of a mobile glass recycling system in accordance with an illustrative embodiment of the present disclosure; the mobile glass recycling system being illustrated in the operational configuration;

FIG. 2 is an enlarged elevational end view of the system of FIG. 1;

FIG. 3 is an elevational side view of the system of FIG. 1;

FIG. 4 is a perspective view of the system of FIG. 1 although, here, the mobile glass recycling system is illustrated in the transport configuration;

FIG. 5 is an enlarged elevational end view of the system shown in FIG. 4;

FIG. 6 is an elevational side view of the system shown in FIG. 4;

FIG. 7 is a top view of the system shown in FIG. 4;

FIG. 8 is a schematic view of the system of FIG. 1;

FIG. 9 is an enlarged fragmentary perspective view of an additional embodiment of a portion of the system of FIG. 1, illustrating a distribution apparatus;

FIG. 10 is an enlarged fragmentary side view of the additional embodiment of FIG. 9; and

FIG. 11 is a schematic view of a mobile glass recycling system in accordance with an additional embodiment of the present disclosure, including the portion illustrated in FIGS. 9 and 10.

### DETAILED DESCRIPTION

A robust and economical mobile glass recycling system and an efficient and effective method for recycling used glass artifacts into external cullet suitable for use in a glass manufacturing plant are described. For example, according to the system and method, a recyclable stream of glass that includes used glass artifacts is received by the system, and the used glass artifacts included in the recyclable stream of glass are crushed, milled, and separated from various contaminants to produce (i) external cullet that is ready to be melted in a glass furnace and (ii) waste that includes fines and non-glass materials such as ferrous metal, non-ferrous metal, and non-metal materials. The external cullet may be melted in the glass furnace along with glass-forming raw materials to produce molten glass from which new glass articles, such as glass containers, may be subsequently formed. The disclosed mobile glass recycling system may be transported to a source of the used glass artifacts and may process or recycle the used glass artifacts into external cullet on-site. In one particular scenario, the mobile glass recycling system is transported to a glass manufacturing plant and, once there, can recycle used glass artifacts into external cullet. The external cullet may then be fed to a glass furnace at the same plant location. In another scenario, the mobile glass recycling system is transported to recycling facility or other location where used glass artifacts are stored, and may recycle the used glass artifacts into the external cullet at that location. The external cullet may then be separately transported to a glass manufacturing plant and fed to a glass furnace.

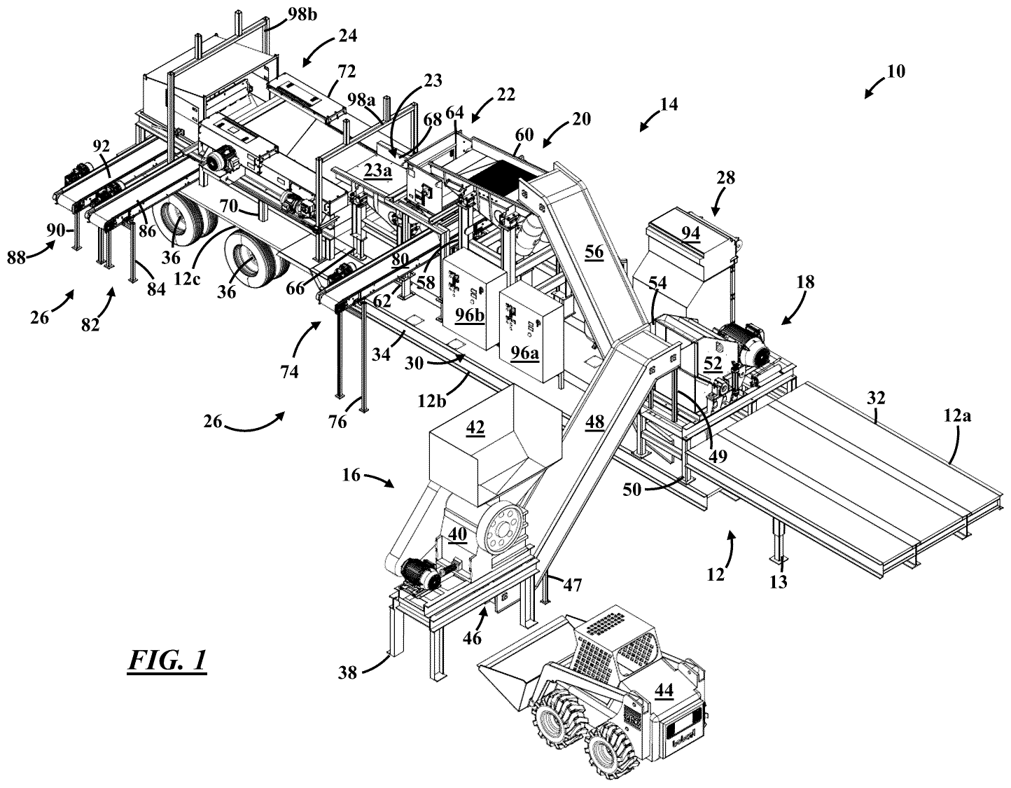

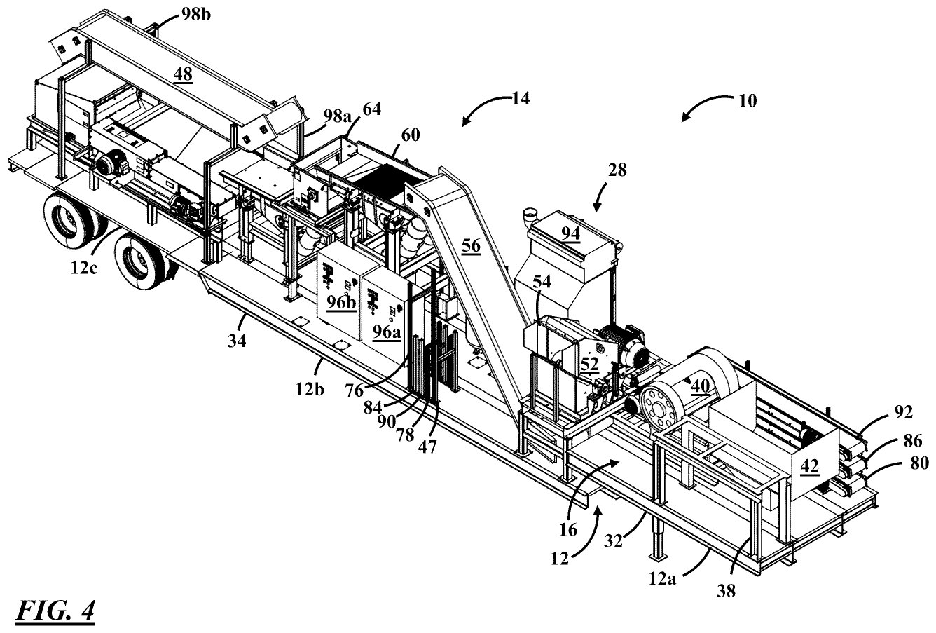

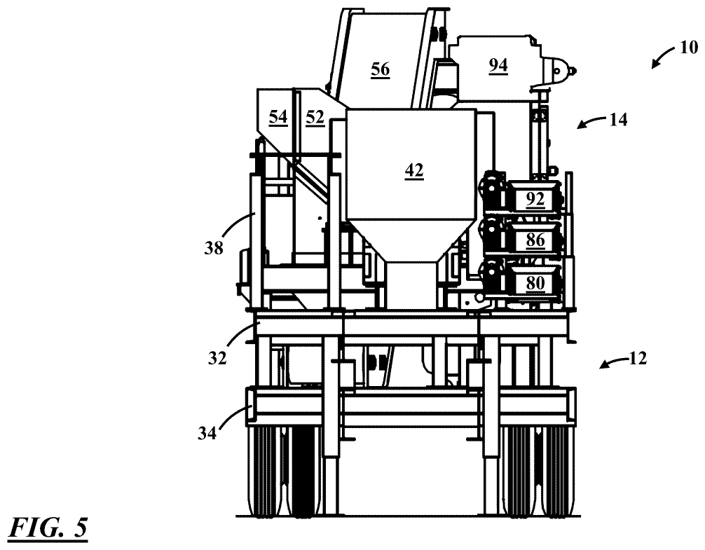

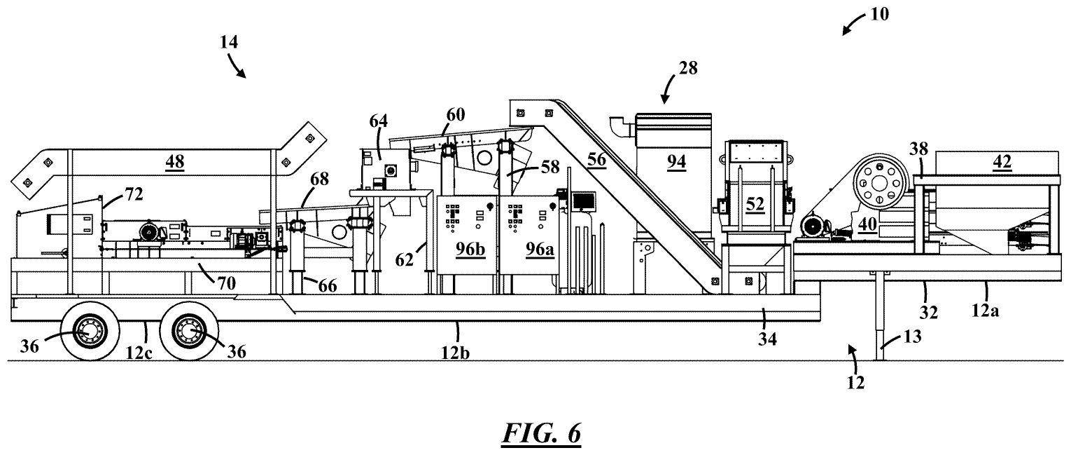

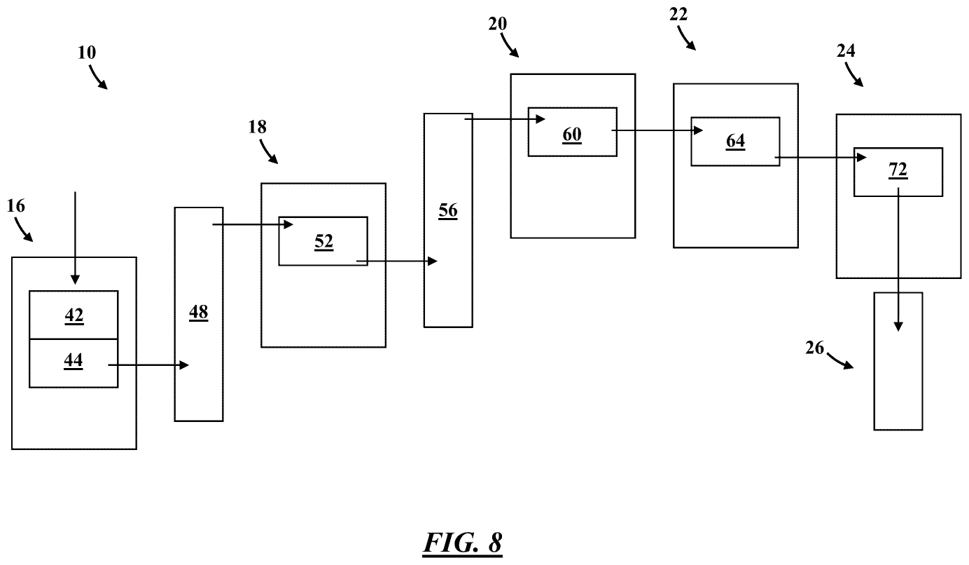

With specific reference to the drawing figures, FIGS. 1-8 shows an illustrative embodiment of a mobile glass recycling system 10 that may be used to recycle used glass artifacts to produce external cullet. The system 10 includes a trailer 12, which carries other portions of the system 10, and glass recycling equipment 14. The trailer 12 includes a forward end 12a, a rearward end 12c, and a central portion 12b disposed between the forward end 12a and the rearward end 12b. All of the glass recycling equipment 14 is carried by the trailer 12 in a transport configuration (FIGS. 4-7) of the system 10 and, additionally, at least some of the glass recycling equipment 14 is carried by the trailer 12 in an operational configuration (FIGS. 1-3) of the system 10. The mobile glass recycling system 10 may be ground transported from one destination to another destination with the glass recycling equipment 14 stowed in the transport configuration. Once the mobile glass recycling system 10 arrives at the destination where glass recycling is to be carried out, the glass recycling equipment 14 is deployed from the transport configuration to the operational configuration and is operated on-site to recycle used glass artifacts, which are typically supplied as part of a recyclable stream of glass to the equipment 14. The used glass artifacts are preferably comprised of glass containers (e.g., bottles and/or jars) and/or fragments of broken glass containers, although it may be possible for the used glass artifacts to include other forms of glass including, fragments of broken glass windows and/or other types of used glass articles and/or fragments thereof. The used glass artifacts may thus encompass a variety of shapes, sizes, and glass chemical compositions.

The trailer 12 may be a semitruck trailer configured for towing, for example, by a class 8 tractor truck (not shown), or by any other vehicle suitable for towing industrial equipment. In a specific example, the trailer 12 may be a lowboy trailer, such as a single-drop-deck trailer, which may be rated to carry on the order of, for example, thirty-five tons of load, although higher and lower load ratings are certainly possible. The illustrated trailer 12 has a longitudinal length extending between the forward end 12a and the rearward end 12c, and transverse width perpendicular to the longitudinal length. The longitudinal length of the trailer 12 is greater than the transverse width. The trailer 12 may include an upper platform 32 extending rearwardly from the forward end 12a of the trailer 12, which may have support legs 13 and a tractor coupling (not separately shown), such as a kingpin, proximate the forward end 12a of the trailer 12. The trailer 12 also may include a lower platform 34 coupled to and extending rearwardly with respect to the upper platform 32 to the rearward end 12c of the trailer 12 and may also encompass the central portion 12b of the trailer 12. The lower platform 34 may be dropped or stepped down abruptly from the upper platform 32 with a 90 degree neck. The lower platform 34 may have one or more wheel axles 36 proximate the rearward end 12c of the trailer 12 that may include spread axles, as shown, or may include axles of any other configuration suitable for the load being carried. The wheel axles 36 may be unimount axles and the trailer 12 may have an air suspension (not separately shown). Each of the wheel axles 36 supports a plurality of laterally spaced apart wheels for rotating engagement with the ground. The trailer 12 may of course be configured differently from what is show here yet still be capable of carrying the glass recycling equipment 14 and, as such, the trailer 12 is not limited to the specific construction shown in the drawings.

The glass recycling equipment 14 includes a glass crushing apparatus 16, a glass milling apparatus 18, an optional fines separating apparatus 20, a ferrous metal separating apparatus 22, and a non-ferrous metal separating apparatus 24. The glass crushing apparatus 16 receives the recyclable stream of glass and crushes the used glass artifacts included therein into crushed glass pieces. The glass milling apparatus 18 receives the recyclable stream of glass after the glass crushing apparatus 16 and further mills the crushed glass pieces into milled glass pieces having a smaller average size-when measured along the largest dimension of the glass pieces—than the crushed glass pieces. The glass crushing and glass milling apparatuses 16, 18 may be located on the trailer 12 proximate the forward end 12a of the trailer 12 in the transport configuration of the system 10, whereas, in the operational configuration of the system 10, at least a portion of the glass crushing apparatus 16 may be deployed and operated off the trailer 12 while the milling apparatus 18 may remain located on the trailer 12. As used herein, the term “proximate” means located closer to one end of the trailer 12 than to an opposite end of the trailer 12.

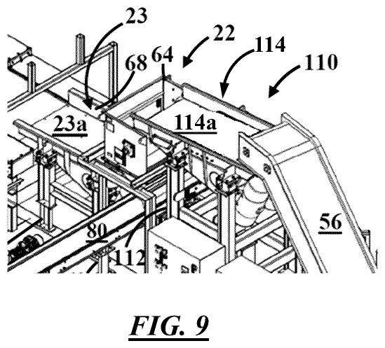

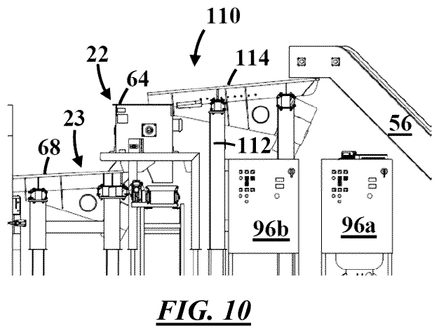

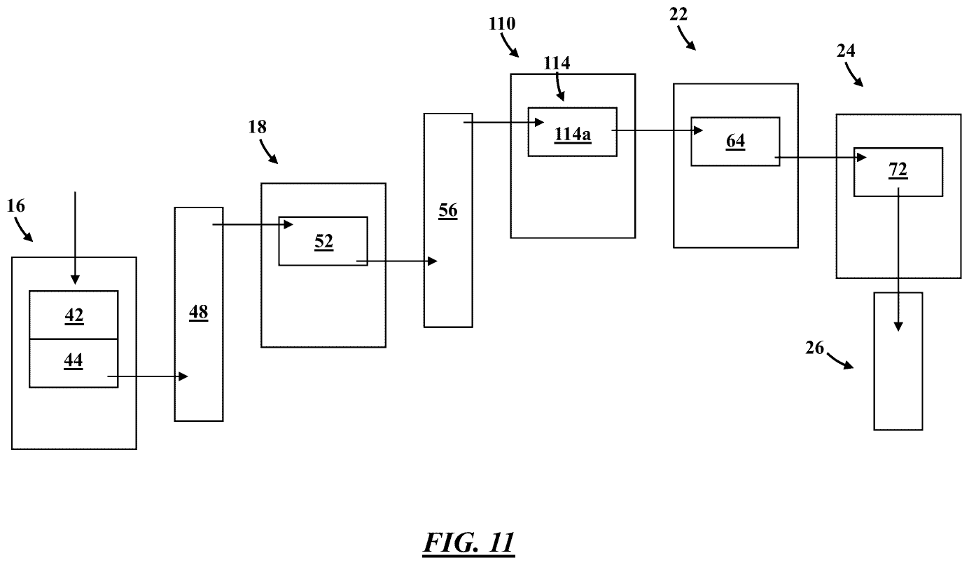

The optional fines separating apparatus 20 may be located operationally downstream of the glass milling apparatus 18 and the ferrous metal separating apparatus 22 may be located operationally downstream of the fines separating apparatus 20. The fines separating apparatus 20, if present, receives the recyclable stream of glass comprising the milled glass pieces and separates fines (i.e., small particles below a minimum size threshold), including pieces of glass that are too small, out of the recyclable stream of glass. If the fines separating apparatus 20 is not needed, a distribution apparatus 110 may be located operationally downstream of the glass milling apparatus 18 and operationally upstream of the ferrous metal separating apparatus 22, as shown in FIGS. 9 and 10 and schematically in FIG. 11. The ferrous metal separating apparatus 22 receives the recyclable stream of glass after the fines separating apparatus 20 (FIGS. 1-8) or the distribution apparatus 110 (FIGS. 9-11), whichever may be present, and separates ferrous metal out of the recyclable stream of glass. The fines and ferrous metal separating apparatuses 20, 22 may be located on the trailer 12 in the central portion 12b of the trailer 12 in both the transport and operational configurations of the system 10.

The non-ferrous metal separating apparatus 24 may be located operationally downstream of the ferrous metal separating apparatus 22. The non-ferrous metal separating apparatus 24 receives the recyclable stream of glass after the ferrous metal separating apparatus 22 and separates non-ferrous metal out of the recyclable stream of glass to produce a stream of external cullet. The recyclable stream of glass becomes the stream of external cullet following the non-ferrous metal separating apparatus 24 since the used glass artifacts initially included in the recyclable stream of glass have been crushed, milled, and separated from fines (optional), ferrous metal, non-ferrous metal, and, optionally, other non-metal materials, by the progression of apparatuses in the glass recycling equipment 14. The non-ferrous metal separating apparatus 24 may be located on the trailer 12 proximate the rearward end 12c of the trailer 12 in both the transport and operational configurations of the system 10. In addition, the glass recycling equipment 14 may also include a distributing apparatus 23 to distribute the recyclable stream of glass over a distribution surface 23a between the ferrous metal separating apparatus 22 and the non-ferrous metal separating apparatus 24, as well as various other ancillary apparatuses including, for instance, at least one conveyor apparatus 26, a dust control apparatus 28, and/or an electrical and controls apparatus 30. A more detailed discussion of the aforementioned apparatuses 16, 18, 20, 22, 23, 24, 26, 28, 30, 110 of the glass recycling equipment 14 is provided below.

The glass crushing apparatus 16 is carried on the trailer 12 in the transport configuration (FIGS. 4-7) of the system 10 and at least a portion of the glass crushing apparatus 16 may be deployed and operated off of the trailer 12 in the operational configuration (FIGS. 1-3) of the system 10. The glass crushing apparatus 16 includes a glass crusher support stand 38 and a glass crusher 40. The glass crusher support stand 38 is carried on the upper platform 32 of the trailer 12 in the transport configuration, and is configured to rest on the ground adjacent to the trailer 12 in the operational configuration. The support stand 38 may include the illustrated table-like structures with platforms and legs, or it may include another type of support structure suitable to support glass recycling equipment. The glass crusher 40 crushes the glass artifacts included in the recyclable stream of glass into the crushed glass pieces, as previously described, which are easier to process and flow through the glass recycling equipment 14. The glass crusher 40 is preferably bottle breaker, such as a jaw crusher, but may be any other crushing device that can crush used glass artifacts. The glass crusher 40 is carried on the upper platform 32 of the trailer 12 in the transport configuration, and is configured to rest on the glass crusher support stand 38 adjacent to the trailer 12 in the operational configuration. The glass crushing apparatus 16 also includes a glass crusher hopper 42 to receive bulk used glass artifacts and to direct the recyclable stream of glass toward and into an inlet of the glass crusher 40. The glass crusher hopper 42 may be carried on the upper platform 32 of the trailer 12 in the transport configuration, and is carried over the glass crusher 40 in the operational configuration.

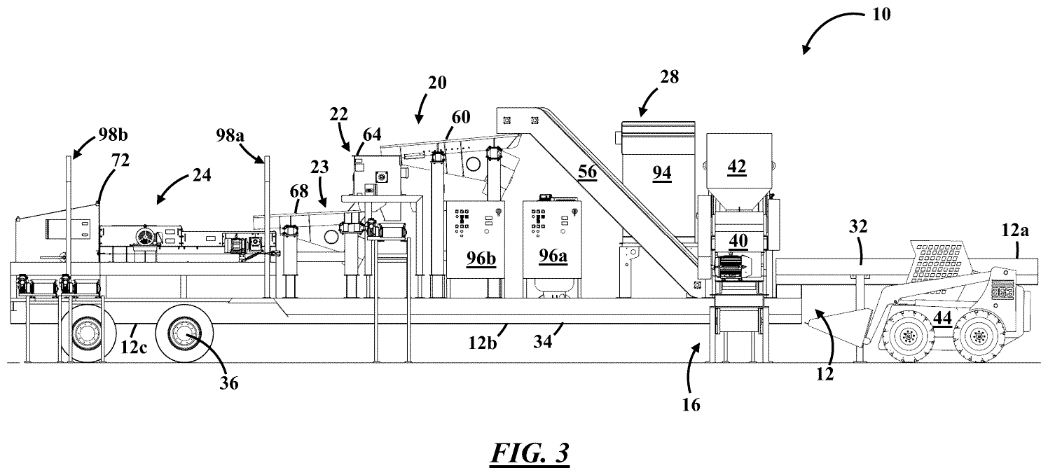

The glass crushing apparatus 16 may be deployed from the transport configuration to the operational configuration manually or by a vehicle 44 such as, for example, a bucket front loader, as shown, or a forklift, skid steer, or any other vehicle suitable to help deploy the glass crushing apparatus 16. In this regard, the height of the upper platform 32 of the trailer 12 is preferably kept at a vehicle accessible height so that, when using the vehicle 44, the crusher support stand 38 and the glass crusher 40 may be retrieved and deployed by forks of the vehicle 44. Likewise, the crusher support stand 38 and the glass crusher hopper 42 may be sized and positioned so that the glass crusher hopper 42 can be fed and receive bulk used glass artifacts by the same or different vehicle 44, which may call for the hopper 42 to support a maximum loading height, for example, of six feet high and a maximum bucket width, for example, of four feet wide. Once in the operational configuration, the glass crusher hopper 42 receives the bulk used glass artifacts, preferably from the vehicle 44 or by some other feeding approach. For example, as shown in FIGS. 1 and 3, the vehicle 44, now equipped with a front load bucket, collects a load of bulk used glass artifacts in its bucket and dumps the load of bulk used glass artifacts into the glass crusher hopper 42. Accordingly, to load the glass crusher hopper 42 and charge the glass crusher 40 with used glass artifacts, it is unnecessary to use an excavator or other large industrial equipment.

The glass crushing apparatus 16 further includes a crushed glass chute 46 to discharge the recyclable stream of glass now comprising the crushed glass pieces from the glass crusher 40. The crushed glass chute 46 may be located below the glass crusher 40 and be coupled thereto in any suitable manner. The glass crushing apparatus 16 may additionally include a crushed glass conveyor 48 to convey the recyclable stream of glass away from the crushed glass chute 46 upwardly and towards the trailer 12. The crushed glass conveyor 48 may include an inclined cleated belt conveyor, as illustrated, or any other conveyor suitable for conveying the recyclable stream of glass. The crushed glass conveyor 48 may be carried by the lower platform 34 in the transport configuration, and, in the operational configuration of the system 10, may have an inlet end configured to be positioned beneath the crushed glass chute 46 and an outlet end configured to be positioned above the lower platform 34 of the trailer 12. The crushed glass conveyor 48 may be supported on an inlet support stand 47 proximate the inlet end and an outlet support stand 49 proximate the outlet end. The outlet support stand 49 is carried on the trailer 12 in both the transport and operational configurations, whereas the inlet support stand 47 is carried on the ground adjacent the glass crusher support stand 38 in the operational configuration.

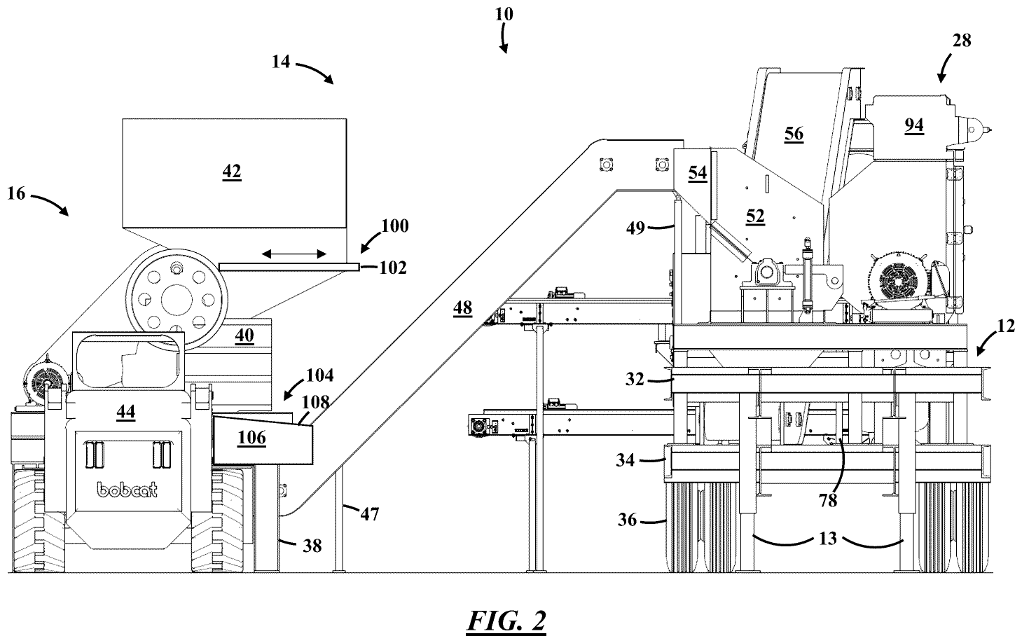

The glass crushing apparatus 16 may include features to help receive the recyclable stream of glass into the glass crusher 40 and/or to meter the recyclable stream of glass including the crushed glass pieces downstream of the glass crusher 40, as shown in FIG. 2. For instance, a slide gate 100 having an actuatable slide plate 102 may be disposed between the glass crusher hopper 42 and the glass crusher 40 to control the flow of the recyclable stream of glass out of the crusher hopper 42. The slide gate 100 may be closed, in which case the slide plate 102 is slid in one direction to decrease a size of a flow path out of the crusher hopper 42 and into the glass crusher 40, to restrict or altogether prevent the flow of the recyclable stream of glass into the inlet of the glass crusher 40. Conversely, the slide gate 100 may be opened, in which case the slide plate 102 is slid in an opposite direction to increase the size of the flow path out of the glass crusher hopper 42 and into the glass crusher 40, to allow the flow of the recyclable stream of glass into the inlet of the glass crusher 40. In this way, the slide gate 100 can be fully or partially closed when loading the glass crusher hopper 42 with bulk used glass artifacts, which allows the used glass artifacts to be loaded quickly into the glass crusher hopper 42 by, for example, the vehicle 44, without overwhelming and jamming the glass crusher 40. The slide gate 100 may then be opened, even progressively over time, to increase the size of the flow path to the glass crusher 40 and thus allow the used glass artifacts to flow to the inlet of the glass crusher 40 at a manageable rate. In the absence of the slide gate 100, the bulk used glass artifacts may have to be feathered into the glass crusher hopper 42 over a period of time-rather than simply dumped quickly into the glass crusher hopper 42—to help manage the flow of the used glass artifacts to the glass crusher 40.

As another example, a vibratory feeder 104 may be arranged to deliver the recyclable stream of glass now comprising the crushed glass pieces from the glass crusher 40. In a preferred arrangement, the vibratory feeder 104 is situated downstream of the crushed glass chute 46. The vibratory feeder 104 includes a vibratory platform 106 having a platform surface 108 over which the recyclable stream of glass, which includes the crushed glass pieces, is fed away from the glass crusher 40 using vibrations to move the recyclable stream of glass. Here, the vibratory feeder 104 helps deliver the recyclable stream of glass comprising the crushed glass pieces to the crushed glass conveyor 48 at a more consistent and controllable flow rate as opposed to dropping the recyclable stream of glass directly onto the crushed glass conveyor 48 from the glass crusher 40 and through the crushed glass chute 46. The vibratory feeder 104 may be used in conjunction with the slide gate 100 or the glass crushing apparatus 16 may include only one of the slide gate 100 or the vibratory feeder 104 depending on the expected operation of the glass crusher 40 and the expected flow the recyclable stream of glass through the glass crushing apparatus 16. The glass milling apparatus 18 is carried on the trailer 12 in the transport configuration and the entire apparatus may be operated on the trailer 12 in the operational configuration.

The glass milling apparatus 18 includes a glass mill support stand 50 carried on the lower platform 34 of the trailer 12 in the transport and operational configurations and a glass mill 52 that mills the crushed glass pieces in the recyclable stream of glass into the milled glass pieces as mentioned above. The glass mill 52 may be located operationally downstream of the glass crusher 40 in the transport configuration. The glass mill 52 may include a hammer mill or any other milling apparatus suitable to mill the crushed glass pieces into the milled glass pieces of a reduced size. The glass mill 52 may be carried on the lower platform 34 of the trailer 12 between the upper platform 32 and the rearward end 12c of the trailer 12 in the transport and operational configurations.

The glass milling apparatus 18 also includes a glass mill hopper 54 to receive the recyclable stream of glass containing the crushed glass pieces from the outlet end of the glass crusher conveyor 48. The glass mill hopper 54 may be carried on the lower platform 34 of the trailer 12 in the transport and operational configurations. The glass milling apparatus 18 further includes a milled glass conveyor 56 to receive the recyclable stream of glass containing the milled glass pieces as discharged from the glass mill 52 and to convey the stream upwardly on the trailer 12. The milled glass conveyor 56 may include an inclined cleated belt conveyor, as illustrated, or any other conveyor suitable for conveying the recyclable stream of glass. The milled glass conveyor 56 may be carried on the lower platform 34 of the trailer 12 in the transport and operational configurations, and has an inlet end configured to be positioned beneath the glass mill 52 and extending in a rearward and upward direction to an outlet end. Preferably, the milled glass pieces included in the recyclable stream of glass exiting the glass mill 52 and being conveyed along the milled glass conveyor 56 are sized between 0.25-inch and one-inch in the largest dimension of the glass pieces.

The optional fines separating apparatus 20 is carried on the trailer 12 in the transport configuration and the entire apparatus 20 may be operated on the trailer 12 in the operational configuration. The fines separating apparatus 20 includes a fines separator support stand 58 carried on the lower platform 34 of the trailer 12 in the transport and operational configurations and a fines separator 60 that separates fines from the recyclable stream of glass that now includes the milled glass pieces. The fines separator 60 separates fines from the recyclable stream of glass that are sized below a minimum size threshold. The minimum size threshold may be established at any desirable particle size to exclude particles of that size and smaller. For example, in a preferred embodiment, the fines separator 60 may separate out particles having a size in the largest dimension of less than 0.25-inches. And, while some glass pieces in the recyclable stream of glass are small enough to be separated out by the fines separator 60, typically such glass exclusions result in less than 5% glass loss from the recyclable stream of glass by weight. The fines separator 60 may be located operationally downstream of the glass mill 52 and may include a vibratory screen to sift fines out of the stream of used glass. The fines separator 60 may be carried on the fines separator support stand 58 in both the transport and operational configurations. Additionally, the fines separator 60 includes an inlet to receive the recyclable stream of glass form the milled glass conveyor 56, a fines outlet to transfer separated fines downwardly onto a corresponding conveyor to carry the fines off the trailer 12, and a glass outlet to transfer the recyclable stream of glass, which now includes the milled glass pieces and from which fines have been removed, for further processing on the trailer 12.

The fines separating apparatus 20 is considered optional because, in some instances, the additional removal of fines from the recyclable stream of glass may be deemed unnecessary and/or the amount of fines contained in the recyclable stream of glass following the glass milling apparatus 18 is already at an acceptable level due to the operating effectiveness of the dust control apparatus 28 to remove fines. If the fines separating apparatus 20 is not employed, the distribution apparatus 110 may instead be located in the same place, as shown in FIGS. 9 and 10 and schematically in FIG. 11. The distribution apparatus 110, like the fines separating apparatus 20, is carried on the trailer 12 in the transport configuration and the entire apparatus 110 may be operated on the trailer 12 in the operational configuration. The distributing apparatus 110 (FIGS. 9-11) includes a distributor support stand 112 and a distributor 114. The distributor support stand 112 is carried on the lower platform 34 of the trailer 12 in the transport and operational configurations. The distributor 114 may be located operationally downstream of the glass mill 52 and may be carried on the distributor support stand 112 in both the transport and operational configurations. The distributor 114 includes a distribution surface 114a over which the recyclable stream of glass, which now includes the milled glass pieces, is distributed. The distributor 114 has an inlet end to receive the recyclable stream of glass onto the distribution surface 114a from the milled glass conveyor 56 and also has an outlet end to transmit the recyclable stream of glass from the distribution surface 114a. The distributor 114 delivers the recyclable stream of glass downstream to the ferrous metal separating apparatus 22 in a metered fashion such that the recyclable stream of glass is spread out and distributed across the distribution surface 114a to facilitate ferrous metal separation. The distributor 114, as illustrated, may include a vibratory feeder, which may include a vibratory platform that provides the distribution surface 114a, or any other distributing apparatus suitable for use in distributing the pieces of milled glass over a surface area.

The ferrous metal separating apparatus 22 is carried on the trailer 12 in the transport configuration and the entire apparatus 22 may be operated on the trailer 12 in the operational configuration. The ferrous separating apparatus 22 includes a ferrous separator support stand 62 and a ferrous separator 64. The ferrous separator support stand 62 is carried on the lower platform 34 of the trailer 12 in the transport and operational configurations. The ferrous separator 64 separates ferrous metal such as, for example, steel container caps, from the recyclable stream of glass that includes the milled glass pieces and from which fines have previously and optionally been removed. The ferrous separator 64 separates ferrous metal from the recyclable stream of glass such that the stream, following ferrous metal removal, preferably contains 5 ppm or less of ferrous metal. The ferrous separator 64 may be located operationally downstream of the fines separator 60, if present, or the distributor 114, and may include a magnetic drum separator, as illustrated, or any other separator that can separate ferrous metal from pieces of glass. The ferrous separator 64 may be carried on the ferrous separator support stand 62 in both the transport and operational configurations. Additionally, the ferrous separator 64 includes an inlet to receive the recyclable stream of glass from the fines separator 60, a ferrous metal outlet to transfer separated ferrous metal downwardly onto a corresponding conveyor to carry the ferrous metal off the trailer 12, and a glass outlet to transfer the recyclable stream of glass, which now includes the milled glass pieces and from which fines (optional) and ferrous metal have been removed, for further processing on the trailer 12.

The distributing apparatus 23 is carried on the trailer 12 in the transport configuration and the entire apparatus 23 may be operated on the trailer 12 in the operational configuration. The distributing apparatus 23 is similar to the other distributing apparatus 110 that may be located between the milling apparatus 18 and the ferrous metal separating apparatus 22 and includes a distributor support stand 66 and a distributor 68. The distributor support stand 66 is carried on the lower platform 34 of the trailer 12 in the transport and operational configurations. The distributor 68 may be located operationally downstream of the ferrous separator 64 and includes a distribution surface 23a over which the recyclable stream of glass, which now includes the milled glass pieces and has had fines (optional) and ferrous metal removed, is distributed. The distributor 68 has an inlet end to receive the recyclable stream of glass onto the distribution surface 23a from the glass outlet of the ferrous separator 64 and also has an outlet end to transmit the recyclable stream of glass from the distribution surface 23a. The distributor 68 delivers the recyclable stream of glass downstream to the non-ferrous metal separating apparatus 24 in a metered fashion such that the recyclable stream of glass is spread out and distributed across the distribution surface 23a to facilitate non-ferrous metal separation. The distributor 68, as illustrated, may include a vibratory feeder, which may include a vibratory platform that provides the distribution surface 23a, or any other distributing apparatus 23 suitable for use in distributing the pieces of milled glass over a surface area.

The non-ferrous metal separating apparatus 24 is carried on the trailer 12 in the transport configuration and the entire apparatus 24 may be operated on the trailer 12 in the operational configuration. The non-ferrous metal separating apparatus 24 includes a non-ferrous separator support stand 70 and a non-ferrous separator 72. The non-ferrous separator support stand 70 is carried on the lower platform 34 of the trailer 12 in the transport and operational configurations. The non-ferrous separator 72 separates non-ferrous metal such as, for example, aluminum container caps, from the recyclable stream of glass that now includes milled glass pieces and from which fines (optional) and ferrous metal have already been removed. The non-ferrous separator 72 separates non-ferrous metal from the recyclable stream of glass such that the stream, following non-ferrous metal removal, preferably contains 5 ppm or less of non-ferrous metal. The non-ferrous separator 72 may be located operationally downstream of the distributor 68 and may include an eddy current separator, as illustrated, or any other separator that can separate non-ferrous metal from pieces of glass. The non-ferrous separator 72 may be carried on the non-ferrous separator support stand 70 in both the transport and operational configurations. Additionally, the non-ferrous separator 72 includes an inlet end to receive the recyclable stream of glass from the outlet end of the distributor 68, a non-ferrous metal outlet to transfer separated non-ferrous metal downwardly onto a corresponding conveyor to carry the non-ferrous metal off the trailer 12, and a cullet outlet to transfer the recyclable stream of glass, which is now considered the stream of external cullet. Accordingly, the stream of external cullet includes milled glass pieces and is preferably devoid of fines, whether removed in by the dust control apparatus 28 or the optional fines separating apparatus 20, while containing 5 ppm or less of ferrous metal and 5 ppm or less of non-ferrous metal.

The conveyor apparatus(es) 26 may be included in the glass recycling equipment 14, as shown specifically in FIG. 1, to remove material separated out of the recyclable stream of glass off of the trailer 12 and/or to direct the stream of external cullet off of the trailer 12 when the apparatus(es) 26 are deployed in the operational configuration. The at least one conveyor apparatus 26 may include (i) a ferrous conveyor apparatus 74 that receives and conveys ferrous metal removed from the recyclable stream of glass by the ferrous separator 64 as well as fines that are removed by the fines separator 60, if present, (ii) a non-ferrous conveyor apparatus 82 that receives and conveys non-ferrous metal removed from the recyclable stream of glass by the non-ferrous separator 72, and (iii) a cullet conveyor apparatus 88 that receives and conveys the stream of external cullet from the non-ferrous separator 72. Each of these apparatuses 74, 82, 88 conveys its respective materials off of the trailer 12 to help support a continuous glass recycling operation.

The ferrous conveyor apparatus 74 is carried on the trailer 12 in the transport configuration and partly operated on the trailer 12 and partly deployed and operated off the trailer 12 in the operational configuration. The ferrous conveyor apparatus 74 includes an outlet end conveyor stand 76, an inlet end conveyor stand 78 (FIG. 2), and at least one ferrous conveyor 80. The outlet end conveyor stand 76 is carried on the lower platform 34 of the trailer 12 in the transport configuration and is configured to rest on the ground adjacent to the trailer 12 in the operational configuration, and the inlet end conveyor stand 78 (FIG. 2) is carried on the lower platform 34 of the trailer 12 in both the transport and operational configurations. The ferrous conveyor 80 conveys ferrous metal discharged from and the ferrous separator 64 off of the trailer 12 and to, for example, a ferrous metal waste hopper (not shown). Additionally, the ferrous conveyor 80 may also convey fines discharged from the fines separator 60 off the trailer 12 to the ferrous metal waste hopper if the fines separator 60 is present. The ferrous conveyor 80 may include an external belt conveyor, as illustrated, or it may include a vibratory conveyor, a pneumatic conveyor, a magnetic conveyor, or any other suitable conveyor. The ferrous conveyor 80 may be carried on the upper platform 32 of the trailer 12 in the transport configuration (FIG. 4) and has an inlet end and an outlet end. In the operational configuration, the inlet end of the ferrous conveyor 80 is carried on the inlet end conveyor stand 78 below the ferrous metal outlet of the ferrous separator 64, and also below fines outlet of the fines separator 60 if present, while the outlet end is carried on the outlet end conveyor stand 76. The at least one ferrous conveyor 80 may be a single conveyor common to both the fines separator 60 (if present) and the ferrous separator 64. But in other embodiments, the at least one ferrous conveyor 80 may include one conveyor dedicated to the fines separator 60 and another conveyor dedicated to the ferrous separator 64.

The non-ferrous conveyor apparatus 82 is carried on the trailer 12 in the transport configuration and partly operated on the trailer 12 and partly deployed and operated off the trailer 12 in the operational configuration. The non-ferrous conveyor apparatus 82 includes an outlet end conveyor stand 84 and a non-ferrous conveyor 86. The outlet end conveyor stand 84 is carried on the lower platform 34 of the trailer 12 in the transport configuration and configured to rest on the ground adjacent to the trailer 12 in the operational configuration. The non-ferrous conveyor 86 conveys non-ferrous metal discharged from the non-ferrous separator 72 off of the trailer 12 and to, for example, a non-ferrous metal waste hopper (not shown). The non-ferrous conveyor 86 may include an external belt conveyor, as illustrated, or it may include a vibratory conveyor, a pneumatic conveyor, a magnetic conveyor, or any other suitable conveyor. The non-ferrous conveyor 86 may be carried on the upper platform 32 of the trailer 12 in the transport configuration (FIG. 4) and has an inlet end and an outlet end. In the operational configuration, the inlet end of the non-ferrous conveyor 86 is carried on the trailer 12, preferably the lower platform 34 of the trailer 12, below the non-ferrous metal outlet of the non-ferrous separator 72 and the outlet end is carried on the outlet end conveyor stand 84 in the operational configuration.

The cullet conveyor apparatus 88 is carried on the trailer 12 in the transport configuration and partly operated on the trailer 12 and partly deployed and operated off the trailer 12 in the operational configuration. The cullet conveyor apparatus 88 includes an outlet end conveyor stand 90 and a cullet conveyor 92. The outlet end conveyor stand 90 is carried on the lower platform 34 of the trailer 12 in the transport configuration and configured to rest on the ground adjacent to the trailer 12 in the operational configuration. The cullet conveyor 92 conveys the stream of external cullet discharged from the non-ferrous separator 72 off of the trailer 12 into, for example, a cullet hopper (not shown) or a cullet pile. The cullet conveyor 92 may include an external belt conveyor, as illustrated, or it may include a vibratory conveyor, a pneumatic conveyor, a magnetic conveyor, or any other suitable conveyor. The cullet conveyor 92 may be carried on the upper platform 32 of the trailer 12 in the transport configuration (FIG. 4) and has a cullet inlet end and a cullet outlet end. In the operational configuration, the cullet inlet end of the cullet conveyor 92 is carried on the trailer 12, preferably the lower platform 34 of the trailer 12, below the cullet outlet of the non-ferrous separator 72 and the cullet outlet end is carried on the outlet end conveyor stand 90.

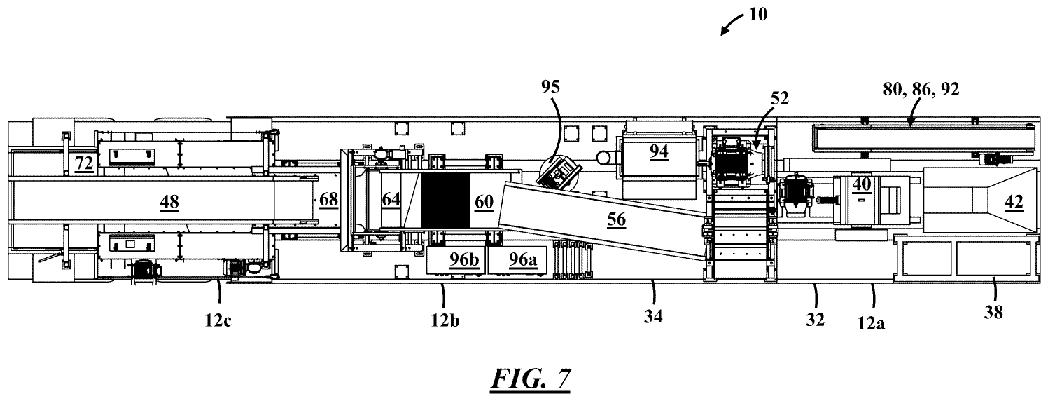

The dust control apparatus 28 is carried on the trailer 12 in the transport and operational configurations and may be operated on the trailer 12 in the operational configuration. The dust control apparatus 28 includes a dust collector 94 that preferably includes a vacuum cyclone separator, although in other implementations the dust collector 94 may include a bag house dust collector or any other dust collecting device suitable for use with glass recycling. The dust control apparatus 28 also may include one or more dust collection ducts (not shown) in pneumatic communication with the dust collector 94 and the glass crusher 40, the glass mill 52, or both the glass crusher 40 and the glass mill 52. The dust collector 94 collects dust during operation of the system 10 and, in particular, during operation of the glass crusher 40 and/or the glass mill 52, and may also collect fines from the glass crusher 40 and/or the glass mill 52 if the dust collector 94 is capable of doing so-thus fully or partially contributing to the feasibility of substituting the distribution apparatus 110 (FIGS. 9-11) for the fine separating apparatus 20 (FIGS. 1-8)—and other relatively lightweight non-metal debris such as fragments of paper, plastic, organics, and other non-metal debris that can be removed from the recyclable stream of glass through suction. Additionally, the dust control apparatus 28 may include a pneumatic compressor 95 (FIG. 7) in pneumatic communication with the dust collector 94 to facilitate self-cleaning of the dust control apparatus 28. For example, the pneumatic compressor 95 may be used to pulse a filter media of the dust collector 94 in order to periodically clean the filter media.

The electrical and control apparatus 30 is carried on the trailer 12 in the transport and operational configurations and may be operated on the trailer 12 in the operational configuration. The electrical and control apparatus 30 includes a first electrical panel 96a, which may be a power distribution panel for receiving power from a source of utility power, an electrical generator, or any other electrical power source. The first electrical panel 96a may distribute electrical power, after first transforming and/or otherwise conditioning the received power, if needed, by way of standard electrical connections to any of the apparatuses 16, 18, 20, 22, 23, 24, 26, 28, 110 or ancillary components of the glass recycling equipment 14 or the trailer 12 that need to be powered. The electrical and control apparatus 30 also includes a second electrical panel 96b, which may be a control panel in electrical communication with the first electrical panel 96a and the various apparatuses 16, 18, 20, 22, 23, 24, 26, 28, 110 of the glass recycling equipment 14, plus any other ancillary components, to control the apparatuses 16, 18, 20, 22, 23, 24, 26, 28, 110 and any of their components individually and to control the system 10 as a whole. The panels 96a, 96b may be carried on the central portion 12b of the trailer 12 on the lower platform 34, and may be carried on support stands coupled to the trailer 12. The panels 96a, 96b may face transversely outwardly with respect to a side of the trailer 12. Power distribution for the system 10 may be sourced by a single electrical power drop to a main disconnect (not separately shown) and is distributed from there to the panels 96a, 96b. Light indicators are used to share the status of operation and equipment. And, although not separately shown, the electrical and control apparatus 30 may include electric controls, motor drives, a power distribution panel, a power disconnect, etc., and all such components may be rated for outdoor use.

With reference now to FIG. 4, the system 10 may include a set of crusher conveyor transport racks 98a, 98b carried by and proximate the rearward end 12c of the trailer 12. The crusher conveyor transport racks 98a, 98b straddle at least a portion of the non-ferrous separator 72 and are configured to carry the crushed glass conveyor 48 in the transport configuration. As shown, for example, each of the crusher conveyor transport racks 98a, 98b may be coupled directly to the lower platform 34 of the trailer 12 and may have uprights between which the conveyor 48 is located. The crusher conveyor transport racks 98a, 98b may be fastened or otherwise coupled to the trailer 12 and are fixed in location on the trailer 12 in both the transport and operational configurations of the system 10. In contrast, the various conveyor stands 47, 76, 78, 84, 90 may be removably coupled to the trailer 12 by fastening feet thereof to the lower platform 34, or by any other suitable manner, so that the conveyor stands 47, 76, 78, 84, 90 will not fall off the trailer 12 during transport but are removable from the trailer 12 for deployment to the operational configuration.

Similar to the various conveyor stands 47, 76, 78, 84, 90, the other conveyors 80, 86, 92 may be removably coupled to the trailer 12 by fasteners, straps, lashing, or some other approach so that they will not fall off the trailer 12 during transport but are removable from the trailer 12 for deployment to the operational configuration of the system 10. Likewise, the glass crusher support stand 38, the glass crusher 40, the glass crusher hopper 42, the vibratory feeder 104, and the crushed glass chute 46 may be removably coupled to the trailer 12 by fasteners, straps, lashing, or some other approach so that they will not fall off the trailer 12 during transport but are removable from the trailer 12 for deployment to the operational configuration. The other apparatuses 18, 20, 22, 23, 24, 110 of the glass recycling equipment 14 may be fastened or otherwise coupled to the trailer 12 and be fixed in location on the trailer 12 in both the transport and operational configurations of the system 10.

The mobile glass recycling system 10 may be configured to produce suitably sized external cullet at a relatively high throughput rate and in a relatively compact envelope while not being a fixed, permanent structure. For instance, the system 10 may receive used glass artifacts in the recyclable stream of glass and process the used glass artifacts to produce a stream of external cullet comprising usable external cullet sized between 0.25-inch and one-inch in the largest dimension of the glass pieces. The stream of external cullet also preferably includes 5 ppm or less of ferrous metal, 5 ppm or less of non-ferrous metal, and is preferably devoid (i.e., of less than 5% by weight) of fines sized less than 0.25-inch in the largest dimension. When operating, the disclosed system 10 may produce between two and four tons of external cullet per hour.

The mobile glass recycling system 10 can be arranged to fit within a transport configuration envelope (corresponding to the transport configuration of the system 10) that is less than 54 feet long, less than 14 feet high, and less than 9 feet wide and, more specifically, is about 53 feet long, about 13 feet high, and about 8.5 feet wide. Accordingly, the transport configuration envelope may be less than 6,900 cubic feet and, more specifically, may be about 5,900 cubic feet. The mobile glass recycling system 10 can also be arranged to fit within an operational configuration envelope (corresponding to the operational configuration of the system 10) that is less than 54 feet long, less than 14 feet high, and less than 27 feet wide and, more specifically, is about 53 feet long, about 13 feet high, and about 25.5 feet wide. Accordingly, the operational configuration envelope is less than 21,000 cubic feet and, more specifically, is about 17,600 cubic feet. As used in this paragraph, the term “about” means within plus or minus 5% of the stated number. Moreover, the equipment is efficiently configured together for transport on the trailer 12 and deployment with respect to the trailer 12, with use of minimal customized structural bracketry for transport and deployment of the equipment. In fact, in the transport configuration, all or most of the equipment is carried by the trailer 12 inboard of an outer perimetric envelope of the trailer 12.

A method of recycling glass may be performed using the mobile glass recycling system 10 described above to produce external cullet. The method includes transporting the mobile glass recycling system 10 to a glass recycling destination that comprises a source of used glass artifacts. The glass recycling destination may be a municipal or commercial recycling center, a glass manufacturing plant, or any other location that includes a recyclable quantity of used glass artifacts. To transport the mobile glass recycling system 10 to its intended destination, the system 10 is arranged into its transport configuration on the trailer 12 and the trailer 12 is coupled to a truck. The truck, in turn, tows or pulls the system 10 to ground transport the system 10 to the recycling destination. Once at the recycling destination, the mobile glass recycling system 10 is deployed into its operational configuration and power is connected to the glass recycling equipment 10 through the first electrical control panel 96a of the electrical and control apparatus 30. The glass recycling equipment 14 is then operated to process the recyclable stream of glass received by the glass recycling equipment 14 into the stream of external cullet delivered from the glass recycling equipment 14.

The glass recycling equipment 14 may be deployed to the operational configuration to prepare the equipment 14 to recycle used glass artifacts. This deployment may include placing the glass crusher stand 38 on the ground adjacent to the trailer 12, locating the glass crusher 40, the vibratory feeder 104, and the crushed glass chute 46 on the glass crusher stand 38, unloading the crushed glass conveyor 48 from the trailer 12, and locating the inlet end of the crushed glass conveyor 48 under the vibratory platform 106 of the vibratory feeder 104 and the outlet end of the conveyor 48 above the glass mill hopper 54, which is located on the trailer 12. The deployment of the glass recycling equipment 14 may additionally include unloading the at least one ferrous conveyor 80 from the trailer 12, locating the inlet end of the ferrous material conveyor 80 below the fines outlet of the fines separator 60, if present, and the ferrous metal outlet of the ferrous separator 64, and locating the outlet end of the ferrous conveyor 80 off of the trailer 12. Still further, the deployment of the glass recycling equipment may include unloading the non-ferrous conveyor 86 from the trailer 12, locating the inlet end of the non-ferrous conveyor 86 below the non-ferrous metal outlet of the non-ferrous separator 72, and locating the outlet end of the non-ferrous conveyor 86 off of the trailer 12. The deployment of the glass recycling equipment 14 may also include unloading the cullet conveyor 92 from the trailer 12, locating the cullet inlet end of the cullet conveyor 92 below the cullet outlet of the non-ferrous separator 72, and locating the outlet end of the cullet conveyor 92 off of the trailer 12.

The glass recycling equipment 14 is operated at the recycling destination in the operational configuration of the system 10 to receive the recyclable stream of glass, which includes the used glass artifacts, crush the used glass artifacts to produce the crushed glass pieces, and mill the crushed glass pieces to produce milled glass pieces. The recyclable stream of glass is received by the glass recycling equipment 14 and, more specifically, the glass crushing apparatus 16. In the particular embodiment described here, the recyclable stream of glass is received by loading bulk used glass artifacts into the glass crusher hopper 42, which feeds the recyclable stream of glass into the inlet of the glass crusher 40, preferably with the aid of the slide gate 100. The bulk used glass artifacts may be loaded into the glass crusher hopper 42 by the vehicle 44 or by some other approach. The recyclable stream of glass is delivered to the glass crusher 40 from the glass crusher hopper 42 and the glass crusher 40 crushes the used glass artifacts included in the recyclable stream of glass into the crushed glass pieces. The recyclable stream of glass comprising the crushed glass pieces is then received by the platform surface 108 of the vibratory platform 106 through crushed glass chute 46. The recyclable stream of glass is discharged onto the inlet end of the crushed glass conveyor 48 from the vibratory platform 106, and the recyclable stream of glass is conveyed away from the vibratory feeder 104 and the glass crusher 40 on the conveyor 48.

The milling apparatus 18 receives the recyclable stream of glass from the crushed glass conveyor 48. Here, in the described embodiment, the recyclable stream of glass is conveyed from the crushed glass chute 46 to the glass mill hopper 54 by the crushed glass conveyor 48 and is received into the glass mill hopper 54. The recyclable stream of glass is delivered by the glass mill hopper 54 to the glass mill 52. The glass mill 52 mills the crushed glass pieces into the milled glass pieces. The recyclable stream of glass comprising the milled glass pieces is then discharged from the glass mill 52 onto the inlet end of the milled glass conveyor 56, which conveys the recyclable stream of glass away from the glass mill 52. Additionally, as the glass crusher 40 is crushing the used glass artifacts and the glass mill 52 is milling the crushed glass pieces, the dust control apparatus 28 may be operated to remove and extract non-metal debris such as dust, paper, plastics, adhesives, etc., from the recyclable stream of glass that may have been originally present in the recyclable stream of glass or created during the glass crushing and glass milling operations, and may additionally be removing fines from the recyclable stream of glass. The collection of the non-metal debris and possibly fines may involve suctioning such materials from the recyclable stream of glass at the glass crusher 40, the glass mill 52, or both, and into the dust collector 94 prior to the recyclable stream of glass being conveyed away from the glass crusher 40 and/or the glass mill 52 on the rushed glass conveyor 48 and/or on the milled glass conveyor 56, respectively.

The optional fines separating apparatus 20 receives the recyclable stream of glass from the milled glass conveyor 56. If the fines separating apparatus 20 is present, the recyclable stream of glass is conveyed from the glass mill 52 to the fines separator 60 by the milled glass conveyor 56 and is received by the fines separator 60. At the fines separator 60, fines are separated out of the recyclable stream of glass, preferably by sifting the fines out of the stream, and the recyclable stream of glass is moved from the inlet of the separator 60 to the glass outlet of the separator 60 while the removed fines are directed to the separate fines outlet of the separator 60. If the distribution apparatus 110 (FIGS. 9 and 10 and schematically in FIG. 11) is substituted for the fines separating apparatus 20, the distribution apparatus 110 receives the recyclable stream of glass from the milled glass conveyor 56 and delivers the stream of glass downstream to the ferrous metal separating apparatus 22. In the disclosed embodiment, the recyclable stream of glass is received onto the distribution surface 114a of the distributor 14 and the stream of glass is distributed across the distribution surface 114a as the stream is conveyed from the inlet end to the outlet end of the distributor 114. The recyclable stream of glass is conveyed on the distribution surface 23a of the distributor 68 and is received by the ferrous separator 64.

After emerging from the glass outlet of the fines separator 60 or the outlet end of the distributor 114, the ferrous metal separating apparatus 22 receives the recyclable stream of glass. In the embodiment shown, the recyclable stream of glass is directed into the ferrous separator 64 and ferrous metal is removed from the stream of glass. The recyclable stream of glass is moved from the inlet of the ferrous separator 64 to the glass outlet of the separator 64 while the removed ferrous metal is directed to the separate ferrous metal outlet of the separator 64. The recyclable stream of glass is transferred from the glass outlet of the ferrous separator 64 and the fines removed by the fines separator 60, if present, and the ferrous metal removed by the ferrous separator 64 are discharged through their respective fines and ferrous metal outlets of the separators 60, 64 onto the ferrous conveyor 80—the conveyor 80 may include a single conveyor for both fines and ferrous metal or dedicated conveyors for each material—of the ferrous conveyor apparatus 74.

The distributing apparatus 23 receives the recyclable stream of glass from the ferrous separator 64 and delivers the stream of glass to the non-ferrous metal separating apparatus 24, although in other implementations the distributing apparatus 23 may be omitted or substituted with some other material delivery apparatus. In the disclosed embodiment, the recyclable stream of glass is received onto the distribution surface 23a of the distributor 68 and the stream of glass is distributed across the distribution surface 23a as the stream is conveyed from the inlet end to the outlet end of the distributor 68. The recyclable stream of glass is conveyed on the distribution surface 23a of the distributor 68 and is received by the non-ferrous separator 72. At the non-ferrous separator 72, non-ferrous metal is removed from the recyclable stream of glass. The recyclable stream of glass is moved from the inlet end to the cullet outlet, from which the recyclable stream of glass emerges as the stream of external cullet, and the non-ferrous metal removed from the recyclable stream of glass is directed to the non-ferrous metal outlet. The stream of external cullet is discharged from the cullet outlet of the non-ferrous separator onto cullet conveyor 92 of the cullet conveyor apparatus 88 and the non-ferrous metal removed from the steam of recyclable cullet by the non-ferrous separator 72 is discharged onto the non-ferrous conveyor 86 of the non-ferrous conveyor apparatus 82. The stream of external cullet is conveyed off of the trailer 12 by the cullet conveyor 92 and is collected. Eventually, the external cullet is added into a glass furnace and melted along with glass-forming raw materials to produce molten glass, and glass articles, such as glass containers, are formed from the molten glass.

The subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. The present disclosure is intended to embrace all such embodiments and modifications of the subject matter of this application, and equivalents thereto, as fall within the broad scope of the accompanying claims.

1. A mobile glass recycling system, comprising:
a trailer;
a glass crusher to crush used glass artifacts included in a recyclable stream of glass fed to the glass crusher into crushed glass pieces, the recyclable stream of glass including the crushed glass pieces being discharged from the glass crusher;
a ferrous separator to separate ferrous metal from the recyclable stream of glass downstream of the glass crusher; and
a non-ferrous separator to separate non-ferrous metal from the recyclable stream of glass downstream of the glass crusher.

2. The mobile glass recycling system set forth in claim 1, further comprising a crushed glass conveyor to convey the recyclable stream of glass discharged from the glass crusher away from the glass crusher.

3. The mobile glass recycling system set forth in claim 2, wherein the glass crusher is deployed off of the trailer and each of the ferrous separator and the non-ferrous separator is carried on the trailer downstream of the glass crusher, and the crushed glass conveyor is arranged to convey the recyclable stream of glass from the glass crusher onto the trailer.

4. The mobile glass recycling system set forth in claim 1, wherein the glass crusher crushes the used glass artifacts into crushed glass pieces having a size between 0.25-inch and one-inch.

5. The mobile glass recycling system set forth in claim 1, further comprising a fines separator to separate fines from the recyclable stream of glass and deliver the recyclable stream of glass to the ferrous separator.

6. The mobile glass recycling system set forth in claim 1, further comprising a distribution apparatus that delivers the recyclable stream of glass to the ferrous separator, the distribution apparatus that delivers the recyclable stream of glass to the ferrous separator comprising a distributor that includes a distribution surface over which the recyclable stream of glass is distributed and delivered to the ferrous separator.

7. The mobile glass recycling system set forth in claim 1, wherein the non-ferrous separator is located downstream of the ferrous separator.

8. The mobile glass recycling system set forth in claim 7, further comprising a distributing apparatus that delivers the recyclable stream of glass to the non-ferrous separator, the distributing apparatus that delivers the recyclable stream of glass to the non-ferrous separator comprising a distributor that includes a distribution surface over which the recyclable stream of glass is distributed and delivered to the non-ferrous separator.

9. The mobile glass recycling system set forth in claim 1, wherein the glass crusher is part of a glass crushing apparatus that also includes a glass crusher hopper to receive bulk used glass artifacts and to direct the recyclable stream of glass into the glass crusher, and a slide gate disposed between the glass crusher hopper and the glass crusher to control a flow of the recyclable stream of glass out of the glass crusher hopper.

10. The mobile glass recycling system set forth in claim 1, further comprising a dust collector that suctions debris from the recyclable stream of glass.

11. The mobile glass recycling system set forth in claim 10, wherein the debris include at least one of dust, fines, fragments of paper, fragments of plastic, or fragments of organics.

12. A method of mobile glass recycling, comprising:
transporting a mobile glass recycling system, which includes glass recycling equipment carried on a trailer, to a glass recycling destination while the mobile glass recycling system is configured in a transport configuration on the trailer;
deploying the glass recycling equipment from the transportation configuration of the mobile glass recycling system to an operational configuration of the mobile glass recycling system; and
receiving a recyclable stream of glass that includes used glass artifacts into the glass recycling equipment and operating the glass recycling equipment to produce a stream of external cullet that is delivered from the glass recycling equipment, the operating of the glass recycling equipment comprising,
crushing the used glass artifacts in the recyclable stream of glass into crushed glass pieces;
separating ferrous metal from the recyclable stream of glass; and
separating non-ferrous metal from the recyclable stream of glass.

13. The method of mobile glass recycling set forth in claim 12, wherein operating the glass recycling equipment further comprises:
discharging the recyclable stream of glass comprising the crushed glass pieces onto a crushed glass conveyor; and
conveying the recyclable stream of glass comprising the crushed glass pieces for additional processing downstream in the glass recycling equipment.

14. The method of mobile glass recycling set forth in claim 12, wherein the stream of external cullet includes 5 ppm or less of ferrous metal and 5 ppm or less of non-ferrous metal.

15. The method of mobile glass recycling set forth in claim 12, further comprising separating fines from the recyclable stream of glass.

16. The method of mobile glass recycling set forth in claim 12, wherein the step of crushing the used glass artifacts in the recyclable stream of glass into crushed glass pieces is carried out upstream of the step of separating ferrous metal from the recyclable stream of glass, and the step of separating ferrous metal from the recyclable stream of glass is carried out upstream of the step of separating non-ferrous metal from the recycling stream of glass.

17. The method of mobile glass recycling set forth in claim 12, wherein the step of receiving the recyclable stream of glass into the glass recycling equipment comprises directing the recyclable stream of glass into a glass crusher from a glass crusher hopper.

18. The method of mobile glass recycling set forth in claim 17, further comprising controlling a flow of the recyclable stream of glass out of the glass crusher hopper and into the glass crusher.

19. The method of mobile glass recycling set forth in claim 12, wherein the step of crushing the used glass artifacts in the recyclable stream of glass into crushed glass pieces is carried out off of the trailer after deploying the glass recycling equipment to the operational configuration of the mobile glass recycling system.

20. The method of mobile glass recycling set forth in claim 12, further comprising suctioning debris from the recyclable stream of glass.

21. A mobile glass recycling system, comprising:
a trailer;
a glass crushing apparatus to receive a recyclable stream of glass comprising used glass artifacts and to crush the used glass artifacts into crushed glass pieces;
a ferrous metal separating apparatus to separate ferrous metal from the recyclable stream of glass; and
a non-ferrous metal separating apparatus to separate non-ferrous metal from the recyclable stream of glass;
wherein each of the glass crushing apparatus, the ferrous metal separating apparatus, and the non-ferrous metal separating apparatus are stowed on the trailer in a transport configuration of the mobile glass recycling system.

22. The mobile glass recycling system set forth in claim 21, further comprising a fines separating apparatus to separate fines from the recyclable stream of glass, and wherein the fines separating apparatus is also stowed on the trailer in the transport configuration of the mobile glass recycling system.

23. The mobile glass recycling system set forth in claim 21, further comprising a dust control apparatus that removes debris from the recyclable stream of glass.

24. The mobile glass recycling system set forth in claim 21, wherein the glass crushing apparatus includes a glass crusher, a glass crusher hopper, and a slide gate to control a flow of the recyclable stream of glass out of the glass crusher hopper and into the glass crusher.

25. The mobile glass recycling system set forth in claim 24, wherein the glass crushing apparatus further comprises a vibratory feeder to deliver the recyclable stream of glass from the glass crusher.

26. The mobile glass recycling system set forth in claim 21, wherein the mobile glass recycling system is deployable from the transport configuration to an operational configuration in which at least part of the glass crushing apparatus is deployed off of the trailer.
